(19) United States
(12) Patent Application Publication
(10) Pub. No.: US 2022/0410318 A1
(43) Pub. Date: Dec. 29, 2022

(54) GALVANOMETER CONTROLLED FIBER OPTIC LASER

(71) Applicant: Super Nova International, Lansing, MI (US)

(72) Inventors: Tong Li, Haslett, MI (US); Chan Hwang, Haslett, MI (US); Samuel McAlvey, Lansing, MI (US)

(21) Appl. No.: 17/845,933

(22) Filed: Jun. 21, 2022

Related U.S. Application Data
(60) Provisional application No. 63/213,953, filed on Jun. 23, 2021.

(51) Int. Cl. B23K 26/364; B23K 26/08; B23K 37/02

(52) U.S. Cl. CPC B23K 26/364; B23K 26/083; B23K 37/0288

(57) ABSTRACT

A laser engraver comprises a generally rectangular housing with an open bottom adapted to rest on supports provided at the top plane of an open carriage. Thumb wheel screws operating in fixed nuts on the left and right sides of the laser housing and resting on supports at the top plane of the carriage allow the laser housing can be raised, lower and tilted. A plate can be removably and adjustably mountable within the housing directly under the laser for carrying smaller objects. A cart capable of carrying objects to be engraved can be moved into the space between the carriage side panels and is provided with height and level adjustments to support an object to be engraved by the laser when the removable plate is taken out of the laser housing.

### CROSS-REFERENCE TO RELATED APPLICATION

This application claims in part the benefit of U.S. Provisional No. 63/213,953 filed on Jun. 23, 2021 the content of which is incorporated herein by reference.

### FIELD OF THE INVENTION

The field of laser engravers and more particularly in mechanisms and structures for variably supporting and changing the orientation and spacing relative to a programmable laser beam in setting up the laser for the engraving process.

### BRIEF SUMMARY OF THE DISCLOSURE

The subject matter disclosed herein includes a laser engraver wherein the laser apparatus mounted within an open bottom housing in such a way to be positioned in a desired location within a X-Y coordinate system. Multiple adjustment systems are provided including (a) screw type adjusters mounted on the side panels of the laser housing for changing the height and angle of the laser housing relative to the top plane of a carriage-like support on which the housing rests, (b) a set of three screw type mechanisms mounted on the inside of the housing for supporting and adjusting the angle of removable plate that can be optionally positioned within the laser housing, and (c) a height and level adjustable cart for placement within a volume provided by the carriage under the laser cabinet for optionally holding a target object to be engraved in which case the aforementioned plate is removed from the laser housing so that the laser beam can be projected through the open bottom of the housing, through the open top of the carriage and onto the target object supported by the cart.

More specifically, the disclosed embodiment includes a cabinet like housing having top, back and side panels and a front door enclosing a galvanometric laser and focusing apparatus all of which are mounted on a system providing an X-Y coordinate system of adjustment for the laser tower and head within the housing. The galvanometric laser is powered by a photon source and a known system of mirrors for directing photometric energy to the laser and moving and/or redirecting the laser beam according to a digitized program defining the ultimate result of the engraving process, be it an image, a system of numbers and letters and or combination thereof.

A first adjustment feature is provided by screw shafts and fixed threaded nut units mounted on the left and right outside panels of the laser housing for adjusting the height and level of the housing relative to the horizontal top plane of a table-like carriage on which the housing rest. The laser housing has an open bottom and a hinged front door that can provide access to the laser. The carriage is also open at the top except for plates or tabs that are located to receive the feet of the adjusters mounted on the sides of the laser housing.

A feature of the illustrated embodiment is a plate which can be removably placed on a system of adjustable supports mounted low on the inside walls of the laser housing. The plate provides a support surface for target object located immediately under and in line with the beam of the downwardly directed laser. The plate is particularly useful for holding smaller objects to be engraved.

In the illustrative embodiment hereinafter described in more detail, the adjustable supports for the removable plate are three in number and are mounted on the inside of the housing and attached to the interior side panels near the bottom of the laser enclosure. There are two adjustable rests on one side of the interior of the housing and a third on the opposite side of the housing and between the three of them, the height and angle of the plate can be adjusted in preparation for an engraving process performed on an object resting on the plate. Because the plate simply sits on the adjustable rests, it can be simply lifted off of the rest and removed so that the bottom of the laser housing is once again open to reach objects located under the housing in the space between the side panels of the carriage described above.

A further, optional feature is provided by cart which can be placed within the spaced between the left or right vertical support panels of the carriage and used to supporting larger objects where they can be addressed by the laser beam. When the cart is used, the aforementioned plate is removed from the laser housing, effectively reopening the bottom of the laser housing so that the beam can pass downwardly through the open bottom of the housing and the open top of the carriage and on to the target object which is supported by the cart. As hereinafter described the cart can include a scissors type height and angle adjustment mechanism as well as an independently top table element for orienting a target object to be engraved appropriately for the engraving process; e.g. to orient the object so that the target surface is essentially level.

### BRIEF DESCRIPTION OF THE DRAWINGS

The features and advantages of the invention as described here and the various combinations of use thereof are hereinafter described with respect to the attached drawings of which:

FIG. 1 is a perspective view of a laser housing resting on a carriage with the front door of the housing closed;

FIG. 2 is a perspective view of the laser housing as shown in FIG. 1 but with the front door of the housing open to show the laser head and tower as well as the X-Y coordinate system for locating the laser head prior to the beginning of an engraving operation.

FIG. 3 is another perspective view of the embodiment of FIG. 1 but from a different angle showing the adjusters on both sides of the laser housing as well as the adjusters on the interior of the housing for a removable plate;

FIG. 4 is a perspective view of the removable inner plate and support system for it from different angle;

FIG. 5 is a perspective view looking up at the underside of the removable inner plate showing details of its supports on one side;

FIGS. 6-8 are perspective views of a cart that can be placed within the space under the carriage to support large objects; and

FIG. 9 is a perspective view of the laser housing with the door open, the housing resting on the carriage, the removeable plate in place within the housing and the cart stored in the space provided by the carriage

### DETAILED DESCRIPTION OF THE ILLUSTRATIVE EMBODIMENT

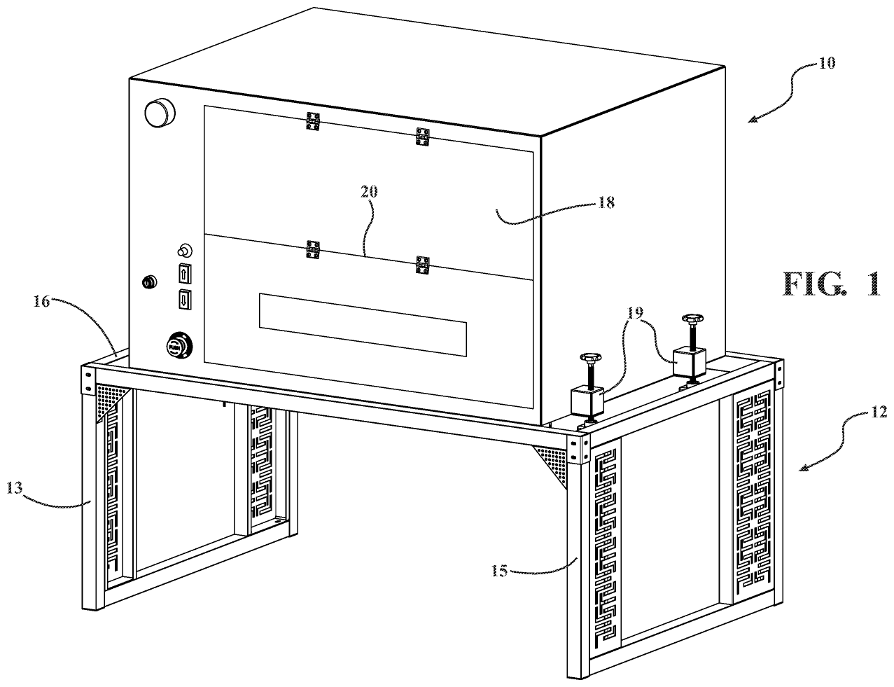

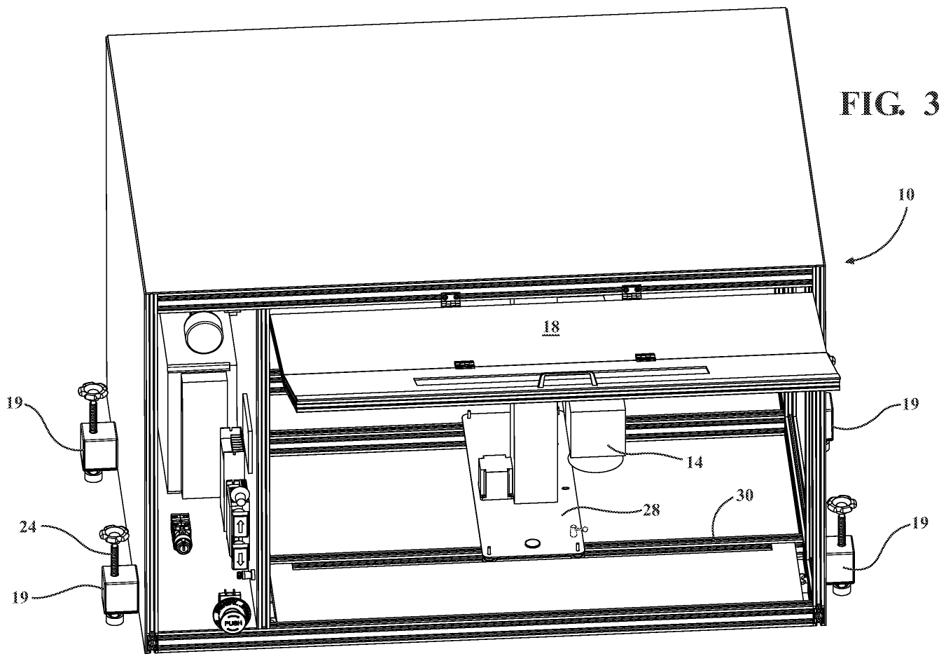

Referring now to FIGS. 1-3 the disclosed embodiment comprises a generally rectangular metal housing 10 resting on a carriage 12 having left and right vertical supports 13 and 15 supporting a rectangular top frame 16 preferably made of aluminum angle irons. The top of the frame 16 is open except for plates or tabs 17 attached to the lateral members of the frame 16 to provide supports for adjusters 19 that are attached such as by welding to the lower outside surfaces of the side panels of the laser housing as shown. The top of the carriage 12 is otherwise open so that, when necessitated by the size and type of the object to be engraved, the laser beam can pass through the open bottom of the housing 10 and the open top of the carriage 12 to reach an object placed between the side panels of the carriage 12. The panels of the carriage 12 are framed with metal members as shown and the decorative interiors can be made of plastic or a light metal as they can be non-weight-bearing structures.

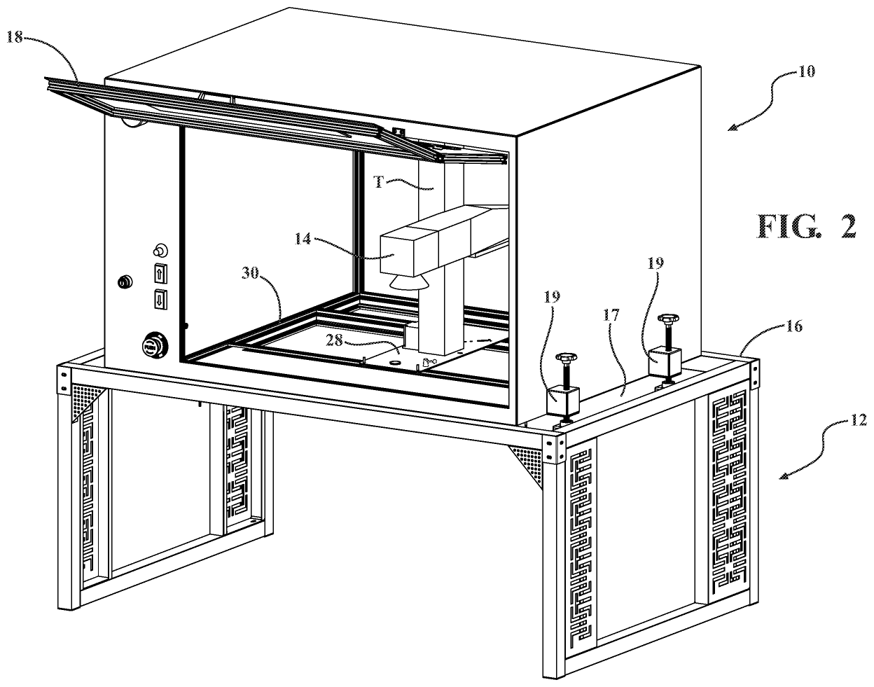

The housing 10 has a front door 18 with horizontal hinges 20 so that it can be raised in a folded fashion as shown in FIG. 2 to provide access to the interior of the housing 10. Toward the left side of the housing 10 is a compartment 21 which contains the power source and the various control components of the galvanometric laser which is mounted on a plate 28 within the interior of the housing. It will be noted that the laser beam is directed downwardly from the head H and that the tower T mounted on plate 28 is provided with suitable power means to raise and lower the head 18 to bring the laser beam into focus on the target object, depending on how it is located and how far it is from the laser beam The plate 28 is moveable along the X-axis tracks 30 by means of wheels (not shown) attached to the plate 28 so as to ride in the tracks 30 to place the laser tower T and head H in the desired position for an engraving operation. The laser itself and the horizontal and vertical adjusters for it are known in the art and are not described in detail. A locking system with a handle H is provided 24 to lock the plate 28 in a desired position. For more information about the power source of the laser reference should be had to U.S. Pat. No. 10,654,127 issued May 19, 2020 to the inventor/owner of this application and the entire contents of the aforementioned patent is incorporated herein by reference.

The leveling devices 19 provide the first adjustment mechanism. These mechanisms include threaded screws 24 that pass through the internally-threaded nut units 19 that are attached to the outside surfaces on both housing side panels o near the bottoms. The screw shafts can be independently manually operated by turning the thumb wheels on the top of the threaded screw shafts to extend or retract the screw shafts vertically. These mechanisms are independently adjustable to raise, lower and/or change the level of the housing relative to the top plane of the carriage as necessary to keep the laser in focus relative to a target surface as the beam moves over the surface of the object during an engraving process. If, for example, the target has a non-level top surface to be engraved, the adjusters on one side of the housing will be operated to raise that side of the housing so that the plane of laser movement corresponds to the plane of the surface of the object to be engraved thereby keeping the laser in focus over the entire range of the pattern to be engraved. In a similar fashion all four of the adjusters can be adjusted to raise and lower the laser housing to accommodate objects of different sizes located between the side panels of the carriage. The adjusters 19 may also be three in number, two on one side as shown, and one on and in the middle of the other side to provide a three-point system that can also adjust both height and angle of the housing 10.

The carriage 12 may be designed and built in various heights; a height of between 30 and 45 inches is generally useful but is not to be seen as limiting.

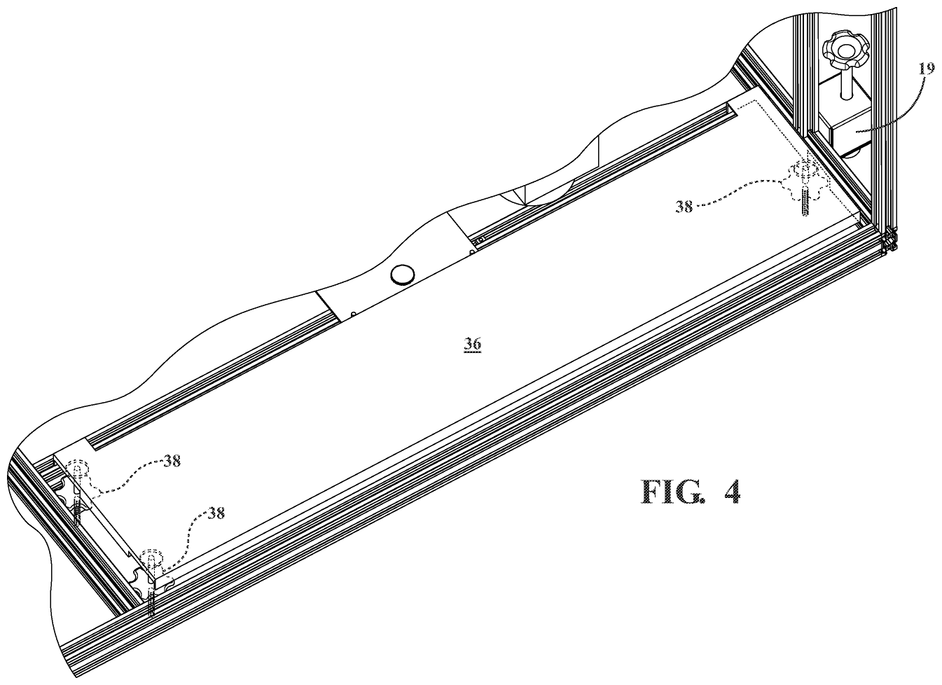

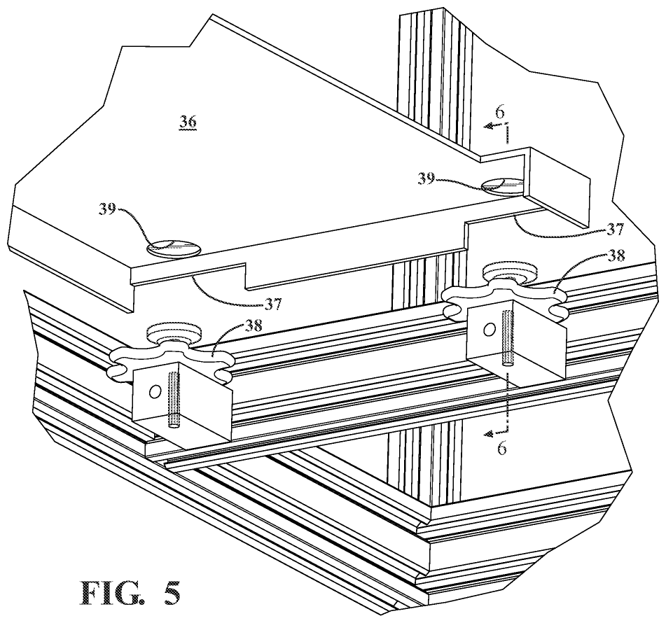

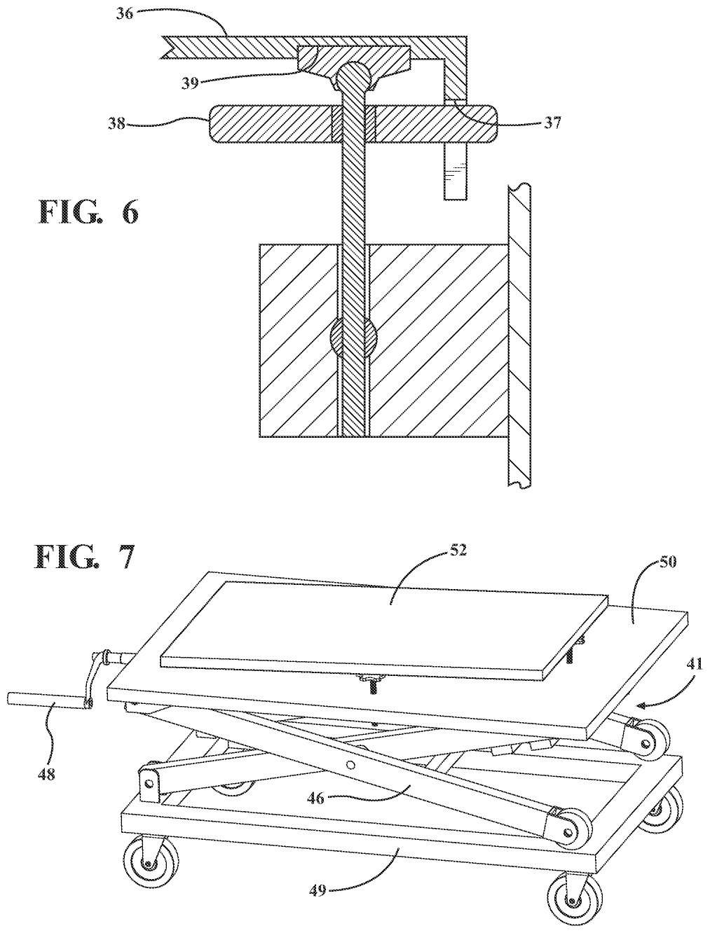

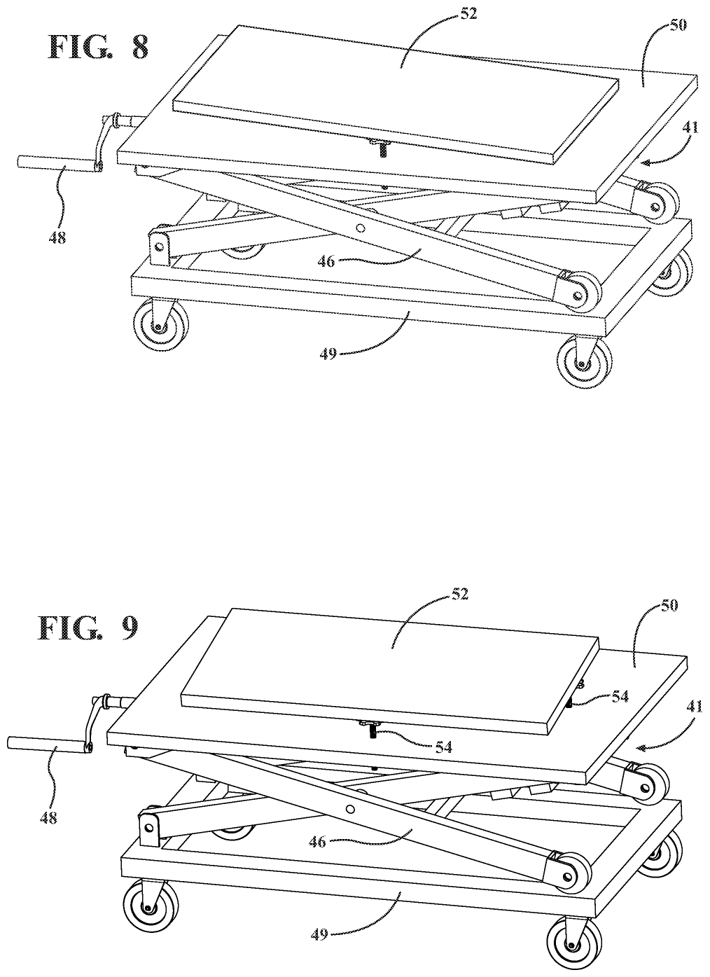

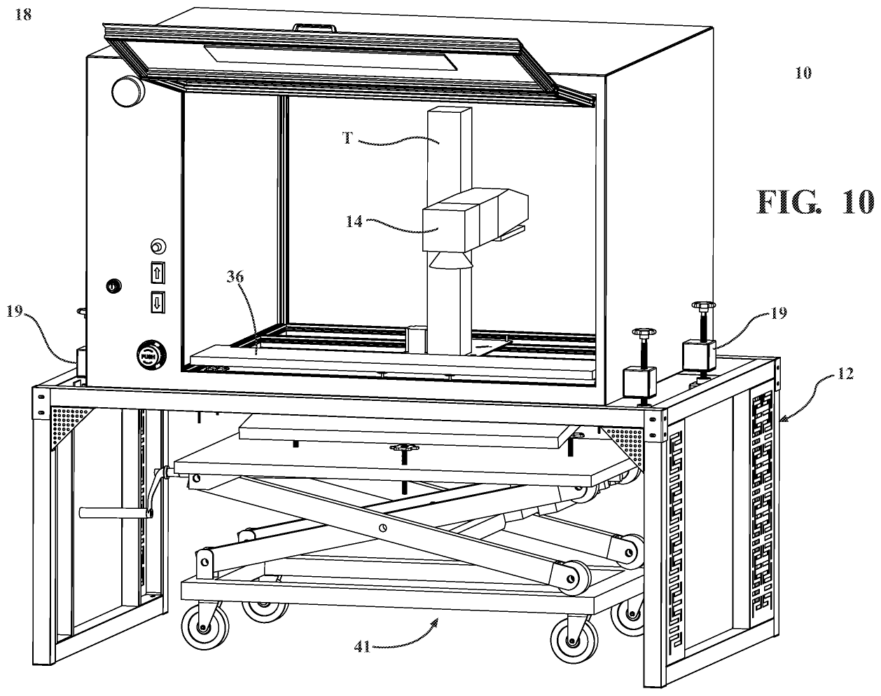

Looking now to FIGS. 4 and 5, a second adjustment feature is provided by a plate 36 removably mounted on screw shaft adjusters 38 attached to and within the laser housing 10 adjacent the lower interior sides of the laser housing below the tracks 30. When in place, the plate 36 effectively closes the bottom of the laser housing 10 to passage of the laser beam. The plate 36 is accessible through the front door 18 of the housing as shown in FIG. 1. Alternatively a separate door may be provided below the door 18. The plate 36 is configured with edge flanges on three sides for rigidity and the end flanges are slotted as shown at 37 so that a portion of the thumbwheel of each adjuster 38 protrudes outwardly enough to allow the user to adjust height and/or angle while the plate 36 remains in place. The adjusters include threaded shafts passing through internally threaded nut boxes similar or identical to adjusters 19 on the outside of the housing. The thumbwheels of the adjusters 38 can have circular caps that fit into recesses 39 in the plate 36 to stabilize the position of the plate in use. There are two adjusters 38 for the plate 36 on one side and one adjuster 38 on the other side. The adjusters are screw shafts with soft plastic elements on the threads to make them operate in a prevailing torque mode, so they do not turn and lose position due to vibration. With this 3-point arrangement the height and angle of the top plane of the plate 36 may be adjusted as needed to level the top surface of an object placed on the plate under the laser to be engraved.

Referring now to remaining figures, a third adjustment mechanism is provided by means of a cart 41 that fits within the side panels of the carriage 12 and includes a wheeled frame 49, a top support member 50 carried by struts 46 which are pivotally connected to the frame and to one another to operate in scissors fashion. A rotatable shaft with a handle 48 is provided for raising and lower the support member 50 by means of the scissors action of the members 46 in a known fashion. In addition, a table 52 is provided with elevation and angle adjustment devices 54 in the form of threaded shafts with heads under the table 52 so that the object to be engraved can be placed on the table 52 and adjusted as necessary for height and angle. When this cart 41 is used, the plate 36 is removed from the housing 10 thereby opening the bottom of the housing so that the laser beam is directed through the open bottom of the housing and through the opening in the surface 14 of the carriage 12 toward the object on the plate member 52 on the cart 41.

By way of summary, there are three independently usable and operable adjustment mechanisms provided for accommodating target objects of various sizes, shapes and contours. The first of these adjustment mechanisms comprises the threaded adjusters 19 which provide adjustable support for the housing 10 relative to the top plane of the carriage 12. The second adjustment mechanism is provided by means of the adjusters 3 for the removable plate 36 and the third adjustment mechanism is provided by means of the cart 41.

FIG. 9 shows the entire system with all three adjustment features available. In this arrangement, the plate 36 is removed if the operator wishes the laser beam to reach fully through the open bottom of the housing 10 to an object on the support surface 52.

It is to be understood that the disclosure centers around an illustrative embodiment and that various modification and additions to this embodiment are possible and will be apparent to persons skilled in the art based on the overall knowledge of the including the disclosure found in U.S. Pat. No. 8,309,881 issued Nov. 13, 2012 to Tong Li of Haslett Mich., the complete disclosure of which is incorporated herein by reference.

What is claimed:

1. A laser engraving of the type including an open bottom housing substantially enclosing a laser capable of producing an engraving-level beam directed vertically toward a target object to be engraved and a carriage supporting the laser housing and having a frame defining a substantially open top plane, said system being characterized in that:
the laser housing is provided with multiple threaded adjusters mounted to outside surfaces of side panels of the housing for selectively adjusting the height and angle of the housing relative to the top plane of the carriage; and
a plate having a top surface for supporting a target object wherein the plate is removably and adjustably mountable on a system of supports within the housing below the laser, the system of supports including multiple adjusters fixedly mounted within a lower portion of the interior of the housing for supporting the plate and adjusting both the angle of the plate surface and the distance between the plate surface and the laser.

2. A laser engraving system as defined in claim 1 wherein the adjusters for the removably mounted plate are three in number.

3. A laser engraving system as defined in claim 1 wherein the housing has front panel with a door moveable between open and closed positions for access to the interior of the housing.

4. A laser engraving system as defined in claim 1 wherein the carriage has laterally spaced apart side frame member with tabs for receiving and supporting the threaded adjusters mounted on the side panels of the laser housing.

5. A laser engraving system as set forth in claim 4 further including a cart which can be placed within the carriage space and between the side panels thereof and under the laser housing for supporting a target object.

6. A laser engraving system as defined in claim 5 wherein the cart includes a top table portion and means for selectively adjusting the height and angle of the top table portion and the surface of the target object to be engraved by the laser.
